(19) United States
(12) Patent Application Publication
(10) Pub. No.: US 2014/0136155 A1
(43) Pub. Date: May 15, 2014

(54) ANALYZING HARDWARE DESIGNS BASED ON COMPONENT RE-USE

(71) Applicant: International Business Machines Corporation, Armonk, NY (US)

(72) Inventors: GHASSAN CHIDIAC, Poughkeepsie, NY (US); Alain R. Le Floc'h, Hopewell Junction, NY (US); Mary A. Mitchell, Chapel Hill, NC (US); Joseph H. Torella, Lagrangeville, NY (US)

(73) Assignee: International Business Machines Corporation, Armonk, NY (US)

(21) Appl. No.: 14/064,829

(22) Filed: Oct. 28, 2013

Related U.S. Application Data
(63) Continuation of application No. 13/675,647, filed on Nov. 13, 2012.

(51) Int. Cl. G06F 17/50

(52) U.S. Cl. CPC G06F 17/5004
USPC 703/1

(57) ABSTRACT

A system for analyzing a design of a hardware device includes a database that stores business and technical information related to a plurality of components included in the design and a hardware design assistant coupled to the database and including a processor for automatically creating a bill of materials based on a computer-aided design assembly of the design and on the business and technical information. Another embodiment of a system for analyzing a design of a hardware device includes a processor and a computer readable storage medium that stores instructions which, when executed, cause the processor to perform operations including obtaining a computer-aided design assembly depicting the design and automatically creating a bill of materials based on the computer-aided design assembly, wherein the bill of materials lists in a hierarchical manner a plurality of components making up the design.

### CROSS REFERENCE TO RELATED APPLICATIONS

This application is a continuation of U.S. patent application Ser. No. 13/675,647, filed Nov. 13, 2012, which is herein incorporated by reference in its entirety.

### FIELD OF THE DISCLOSURE

The present disclosure relates generally to hardware development and relates more specifically to the design of hardware products using pre-existing components.

### BACKGROUND OF THE DISCLOSURE

Hardware development engineers are typically encouraged to re-use pre-existing components (e.g., parts, sub-assemblies, and assemblies) when designing or modifying hardware products. However, technical and business information about these components is not often readily accessible to developers at the time of design. Instead, the information is typically distributed across multiple databases having different user interfaces.

Thus, collecting the information tends to be a manual process, leading most developers to forego review of the information until later in the design cycle. However, this delay can create a churn in the design cycle if the developer discovers information that discourages the use of a selected component in the new design.

FIG. 1, for example, is a flow diagram illustrating a typical approach to hardware design. As illustrated, the developer may first create or modify a computer aided design (CAD) assembly for a hardware product, and then manually create a structured bill of materials (BOM) identifying the components needed to manufacture the new hardware product. The developer may next access an enterprise database to look up the attributes for each component listed in the BOM.

Armed with the attributes, the developer will need to analyze each component listed in the BOM for business compliance. This may require the developer to obtain information about each component's availability, quality, or cost (or other metric). Since it is unlikely that all of the necessary information will be available from a single source, the developer will likely have to consult multiple databases, including parts information databases, supplier information databases, and availability/cost databases. If any of this information indicates that a given component listed in the BOM cannot feasibly be included in the hardware product, the developer may have to start all over (time permitting) by searching for alternative components with which to modify the design.

### SUMMARY OF THE DISCLOSURE

A system for analyzing a design of a hardware device includes a database that stores business and technical information related to a plurality of components included in the design and a hardware design assistant coupled to the database and including a processor for automatically creating a bill of materials based on a computer-aided design assembly of the design and on the business and technical information.

Another embodiment of a system for analyzing a design of a hardware device includes a processor and a computer readable storage medium that stores instructions which, when executed, cause the processor to perform operations including obtaining a computer-aided design assembly depicting the design and automatically creating a bill of materials based on the computer-aided design assembly, wherein the bill of materials lists in a hierarchical manner a plurality of components making up the design.

A computer readable storage medium stores instructions for supporting a distributed application which, when executed by a processor, cause the processor to perform operations including obtaining a computer-aided design assembly depicting the design and automatically creating a bill of materials based on the computer-aided design assembly, wherein the bill of materials lists in a hierarchical manner a plurality of components making up the design.

### BRIEF DESCRIPTION OF THE DRAWINGS

The teachings of the present disclosure can be readily understood by considering the following detailed description in conjunction with the accompanying drawings, in which:

FIG. 1 is a flow diagram illustrating a typical approach to hardware design;

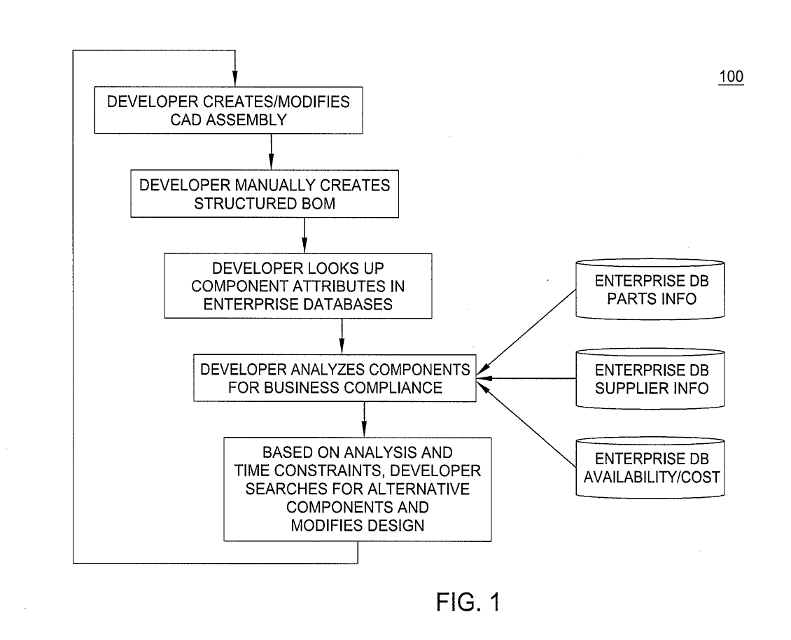

FIG. 2 is a block diagram illustrating one embodiment of a hardware design assistant, according to embodiments of the present invention;

FIG. 3 illustrates an exemplary bill of materials generated from within a computer aided design tool by the bill of materials extractor illustrated in FIG. 2;

FIG. 4 illustrates an exemplary scored bill of materials generated by the component use analyzer illustrated in FIG. 2;

FIG. 5 is a flow diagram illustrating one embodiment of a method 500 for analyzing a hardware design, according to the present invention; and

FIG. 6 is a high level block diagram of the present invention implemented using a general purpose computing device.

To facilitate understanding, identical reference numerals have been used, where possible, to designate identical elements that are common to the Figures.

### DETAILED DESCRIPTION

In one embodiment, the present invention is a method and apparatus for analyzing hardware designs based on re-use of components. Embodiments of the invention help hardware developers validate selected re-used components (e.g., parts, sub-assemblies, or assemblies) early in the design process, based on current business and technical information. Further embodiments of the invention recommend alternative components when selected components cannot be validated. The design process is therefore streamlined by making business and technical information automatically available to developers at the time of design.

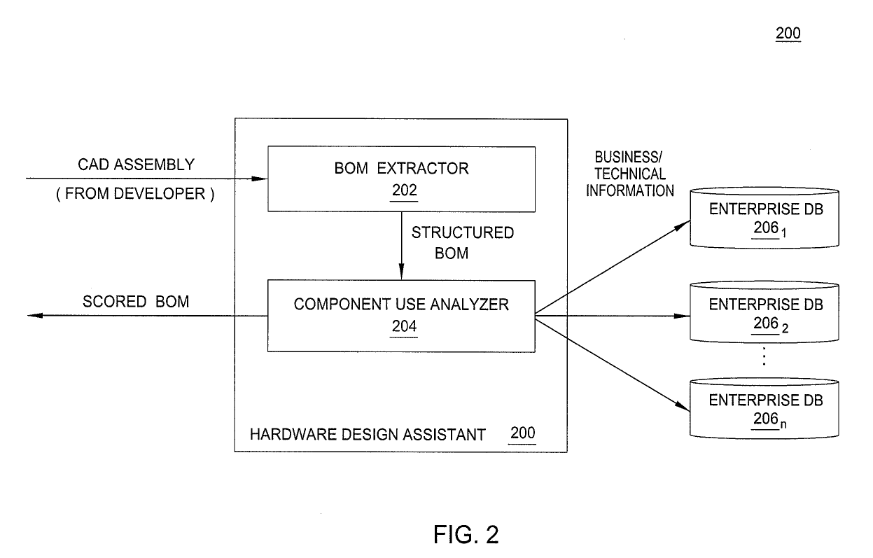

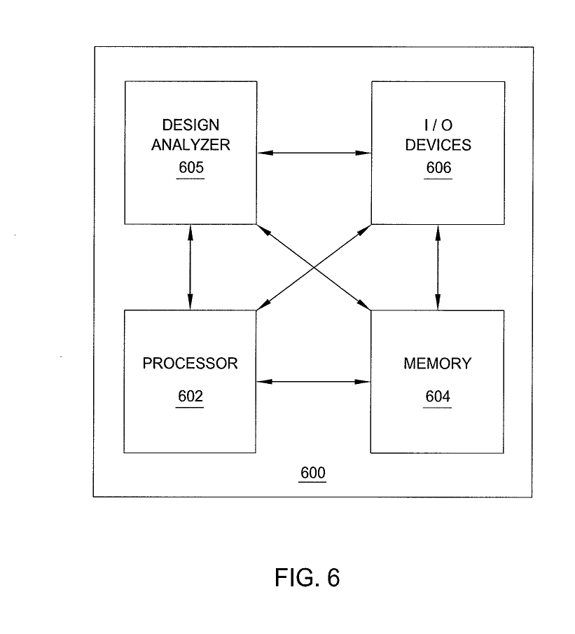

FIG. 2 is a block diagram illustrating one embodiment of a hardware design assistant 200, according to embodiments of the present invention. In one embodiment, the hardware design assistant 200 may comprise a general purpose computer configured for use as a special purpose computer as illustrated in FIG. 6 and discussed below. In one embodiment, the hardware design assistant 200 may perform the methods and algorithms discussed below related to hardware design analysis.

In particular, the hardware design assistant 200 receives computer aided design (CAD) assemblies representing hardware designs (including re-used pre-existing components) and automatically analyzes and validates the hardware designs based on business and technical information. To this end, the hardware design assistant 200 generally comprises a bill of materials (BOM) extractor 202 and a component use analyzer 204.

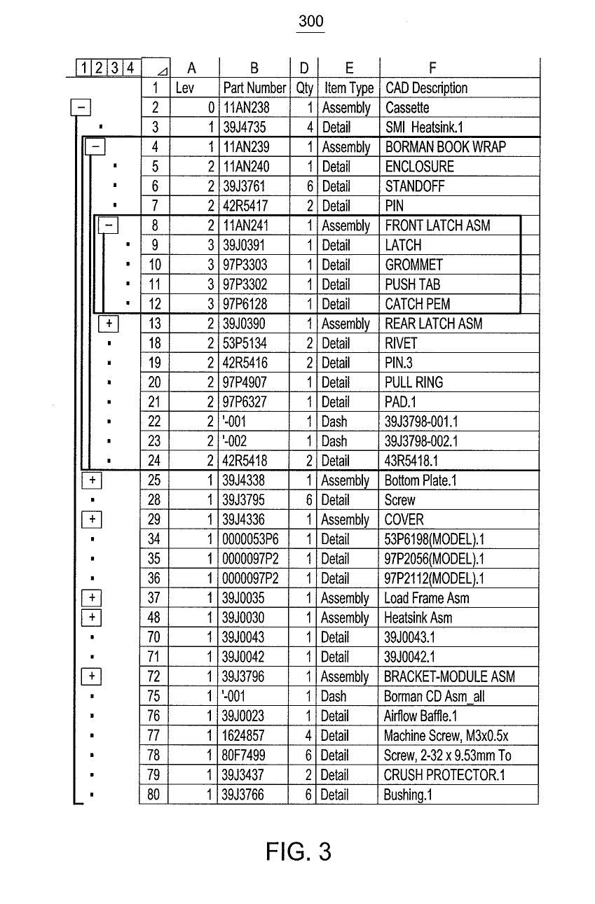

The BOM extractor 202 receives the CAD assemblies from developers and automatically creates a hierarchical or structured BOM in substantially real time (i.e., substantially immediately subject to any system delays). In one embodiment, the BOM is automatically created from within the CAD tool in a format that is familiar to mechanical engineers or designers. For instance, in one embodiment, the BOM is structured as a spreadsheet in which sub-assemblies can be collapsed or expanded, and quantities are listed for each component in each of the sub-assemblies. FIG. 3, for example, illustrates an exemplary BOM 300 generated from within a CAD tool by the BOM extractor 202.

As illustrated in FIG. 3, the BOM 300 created by the BOM extractor 202 is easy to browse. The components of the design are listed in a manner that reflects the design structure hierarchy (e.g., assembly, sub-assembly, part), which makes it easy to identify the relationships between components. The BOM 300 also distinguishes between real items (e.g., items to be included in a manufacturing BOM, which have part numbers) and virtual items (e.g., templates, form tools, components of welded assemblies, and other items included mainly to accommodate the CAD tool). Further embodiments of the BOM 300 list component attributes in addition to the attributes available from the CAD tools, such as business information attributes (e.g., supplier, lead time, availability, environmental compliance, cost, quality, life cycle, etc.), which enable a more complete evaluation of a given component. One embodiment of the BOM 300 excludes inactive parts from the design structure. In one embodiment, the format of the BOM is consistent and does not vary with the type of CAD tool used.

Referring back to FIG. 2, the BOM extractor 202 is coupled to the component use analyzer 204, which receives the structured BOM from the BOM extractor 202. The component use analyzer 204 is further coupled to a plurality of enterprise databases 206₁-206ₙ, (hereinafter collectively referred to as “databases 206”). These databases 206 comprise databases of technical and business data for a particular business entity (e.g., the producer of the hardware product). Thus, the databases 206 may include one or more of: a parts information database, a supplier information database, or an availability/cost database, although other types of databases may also be included.

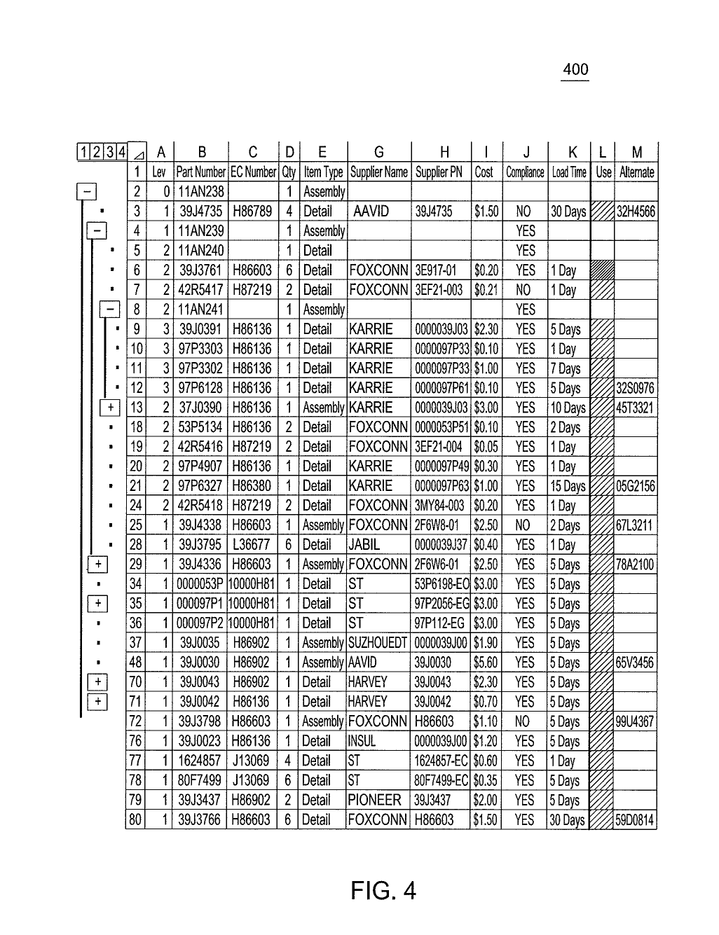

The component use analyzer 204 searches the databases 206 for each component listed in the BOM and analyzes any available information in substantially real time (i.e., substantially immediately, subject to any network delays). The component use analyzer 204 scores each component in the BOM according to this analysis, where the score indicates whether the component should be used in the design. For instance, the score may indicate that the particular component is “preferred” if the component is an optimal choice for the design based on business and technical considerations. Alternatively, the score may indicate that an “alternate” component should be used if the particular component is a sub-optimal choice. In one embodiment, the component use analyzer 204 recommends a specific alternate component. The component use analyzer 204 adds the score information to the BOM to create an updated BOM that the component use analyzer 204 then outputs for review (e.g., by the developer). FIG. 4, for example, illustrates an exemplary updated BOM 400 generated by the component use analyzer 204. As illustrated, the exemplary updated BOM 400 includes a plurality of additional fields not included in the initial BOM 300, including fields that list business or technical information for each component (e.g., supplier name, supplier part number (PN), cost, compliance, and lead time) and fields that indicate whether each component should be used (or re-used; e.g., Yes/No, suggested alternate components).

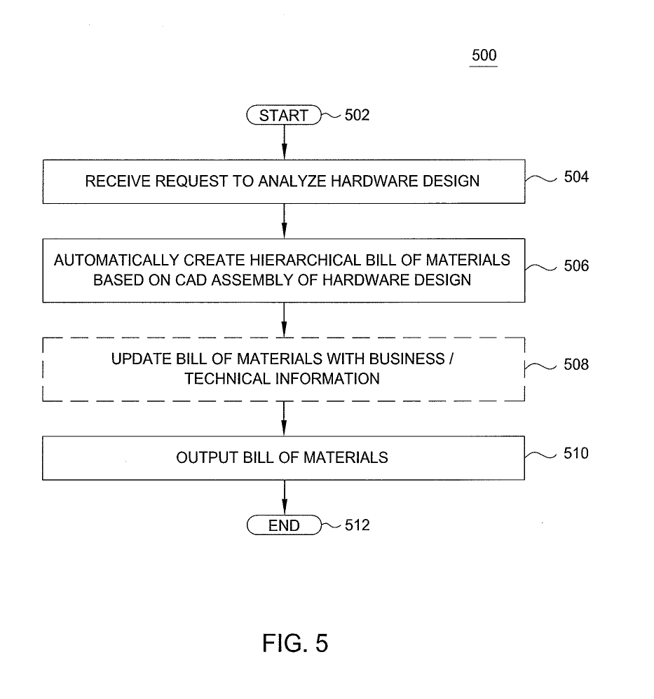

FIG. 5 is a flow diagram illustrating one embodiment of a method 500 for analyzing a hardware design, according to the present invention. The method 500 may be implemented, for example, by the hardware design assistant 200 illustrated in FIG. 2. As such, reference is made in the discussion of the method 500 to various components of the hardware design assistant 200. It will be appreciated, however, that the method 500 is not limited by the configuration of the hardware design assistant 200.

The method 500 begins in step 502. In step 504, the hardware design assistant 200 receives a request (e.g., from a hardware developer) to analyze a hardware design. In one embodiment, the design is either a new hardware design or a modification to an existing hardware design. The hardware design includes at least one re-used, pre-existing component. The request includes the CAD assembly of the hardware design.

In step 506, the BOM extractor 202 automatically (i.e., without manual human intervention) creates a hierarchical BOM based on the CAD assembly received in step 504. In one embodiment, creation of the BOM includes querying the product structure from the CAD tool and creating an assembly listing. The assembly listing includes the level (e.g., zero, one, two, etc.), item type (e.g., part, assembly, virtual item), quantity, and CAD attributes of each component in the hardware design. The components are then grouped (e.g., in spreadsheet form) by level to create a hierarchical listing of all components at all levels of the hardware design (e.g., assemblies, sub-assemblies within the assemblies, and parts within the sub-assemblies). This grouping allows sub-assemblies to be expanded and collapsed for viewing. In further embodiments, the BOM distinguishes between real items and virtual items, as discussed above (e.g., virtual items may be identified by the developer in the CAD tool according to a particular convention). One embodiment of the BOM excludes inactive parts from the design structure.

In optional step 508 (illustrated in phantom), the component use analyzer 204 updates the BOM created by the BOM extractor 202. In particular, the component use analyzer 204 indicates whether one or more of the components listed in the BOM is considered an optimal component for use (or re-use) in the hardware design. For example, as discussed above, business and technical considerations may influence whether a given component is preferred or approved for use in the hardware design or whether an alternate component would be better. These business and technical considerations may be represented in one or more databases queried by the component use analyzer 204. In one embodiment, the component use analyzer 204 queries these databases for each component in the BOM. Any updates made by the component use analyzer 204 result in an updated BOM.

In step 510, the hardware design assistant 200 outputs the BOM or updated BOM for review by the hardware developer. In one embodiment, outputting the BOM or updated BOM includes storing the BOM or updated BOM on the developer's computing device. The method 500 then ends in step 512. However, if review of the BOM or updated BOM by the hardware developer results in a modification to the CAD assembly, the method 500 may be invoked again to analyze the modified CAD assembly. In this case, the same steps discussed above are repeated for the modified CAD assembly.

The hardware design assistant 200 thus uses the method 500 to gather and display data related to a proposed hardware design in a comprehensive and easy-to-read manner. Having this information readily available allows the hardware developer to make decisions regarding component re-use early in the design process, thereby accelerating the overall design process.

FIG. 6 is a high level block diagram of the present invention implemented using a general purpose computing device 600. In one embodiment, the general purpose computing device 600 is deployed as a hardware design assistant, such as the hardware design assistant 200 illustrated in FIG. 2. It should be understood that embodiments of the invention can be implemented as a physical device or subsystem that is coupled to a processor through a communication channel. Therefore, in one embodiment, a general purpose computing device 600 comprises a processor 602, a memory 604, a design analyzer module 605, and various input/output (I/O) devices 606 such as a display, a keyboard, a mouse, a modem, a microphone, speakers, a touch screen, an adaptable I/O device, and the like. In one embodiment, at least one I/O device is a storage device (e.g., a disk drive, an optical disk drive, a floppy disk drive).

Alternatively, embodiments of the present invention (e.g., design analyzer module 605) can be represented by one or more software applications (or even a combination of software and hardware, e.g., using Application Specific Integrated Circuits (ASIC)), where the software is loaded from a storage medium (e.g., I/O devices 606) and operated by the processor 602 in the memory 604 of the general purpose computing device 600. Thus, in one embodiment, the design analyzer module 605 for analyzing hardware designs based on component re-use described herein with reference to the preceding Figures can be stored on a tangible or non-transitory computer readable medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise many other varied embodiments that still incorporate these teachings.

What is claimed is:

1. A system for analyzing a design of a hardware device, the system comprising:
a database that stores business and technical information related to a plurality of components included in the design; and
a hardware design assistant coupled to the database and including a processor for automatically creating a bill of materials based on a computer-aided design assembly of the design and on the business and technical information.

2. A system for analyzing a design of a hardware device, the system comprising:
a processor; and
a computer readable storage medium that stores instructions which, when executed, cause the processor to perform operations comprising:
obtaining a computer-aided design assembly depicting the design; and
automatically creating a bill of materials based on the computer-aided design assembly, wherein the bill of materials lists in a hierarchical manner a plurality of components making up the design.

3. A computer readable storage medium that stores instructions for supporting a distributed application which, when executed by a processor, cause the processor to perform operations comprising:
obtaining a computer-aided design assembly depicting the design; and
automatically creating a bill of materials based on the computer-aided design assembly, wherein the bill of materials lists in a hierarchical manner a plurality of components making up the design.

4. The computer readable storage medium of claim 3, wherein the automatically creating the bill of materials comprises:
querying a structure of the design from a tool in which the computer-aided design assembly was created; and
constructing an assembly listing from the structure, wherein the assembly listing groups the plurality of components according to respective levels of the plurality of components in a hierarchy of the design.

5. The computer readable storage medium of claim 4, wherein the assembly listing indicates, for each of the plurality of components, at least one of: a component type, a quantity, or a computer-aided design attribute.

6. The method of claim 4, wherein the operations further comprise:
querying a database for business and technical information related to the plurality of components; and
automatically updating the bill of materials to include the business and technical information, wherein the automatically updating results in an updated bill of materials.

7. The computer readable storage medium of claim 6, wherein the business and technical information indicates a supplier of at least one of plurality of components.

8. The computer readable storage medium of claim 6, wherein the business and technical information indicates a part number of at least one of plurality of components.

9. The computer readable storage medium of claim 6, wherein the business and technical information indicates a cost of at least one of plurality of components.

10. The computer readable storage medium of claim 6, wherein the business and technical information indicates a compliance of at least one of plurality of components.

11. The computer readable storage medium of claim 6, wherein the business and technical information indicates an availability of at least one of plurality of components.

12. The computer readable storage medium of claim 6, wherein the automatically updating further comprises:
automatically validating an inclusion of the plurality of components in the design.

13. The computer readable storage medium of claim 12, wherein the automatically validating comprises, for a given one of the plurality of components:
confirming inclusion of the given one of the plurality of components in the design, when the business and technical information indicates that the given one of the plurality of components is an optimal choice for inclusion in the design; and
rejecting inclusion of the given one of the plurality of components in the design, when the business and technical information indicates that the given one of the plurality of components is not an optimal choice for inclusion in the design.

14. The computer readable storage medium of claim 13, wherein the rejecting further comprises:
identifying an alternate component to be used in place of the given one of the plurality of components in the design.

15. The computer readable storage medium of claim 13, wherein the operations further comprise:
outputting the updated bill of materials for review by a human user.

16. The computer readable storage medium of claim 3, wherein the operations further comprise:
outputting the bill of materials for review by a human user.

17. The computer readable storage medium of claim 3, wherein at least one of the plurality of components is a pre-existing component that is re-used in the design.

18. The computer readable storage medium of claim 3, wherein the bill of materials is constructed as a spreadsheet.

19. The computer readable storage medium of claim 3, wherein the design includes a modification to a previously analyzed design of the hardware device.

20. The computer readable storage medium of claim 3, wherein each of the plurality of components is one of: an assembly, a sub-assembly, or a part.
